(19) United States
(12) Patent Application Publication
(10) Pub. No.: US 2017/0092388 A1
(43) Pub. Date: Mar. 30, 2017

(54) CONDUCTIVE COMPOSITES AND COMPOSITIONS FOR PRODUCING THE SAME, AND PRODUCTION METHODS THEREOF

(71) Applicants: SAMSUNG ELECTRONICS CO., LTD., Suwon-si (KR); The Industry & Academic Cooperation in Chungnam National University, Daejeon (KR); KOREA RESEARCH INSTITUTE OF CHEMICAL TECHNOLOGY, Daejeon (KR)

(72) Inventors: Sang Eui LEE, Hwaseong-si (KR); Yeonggyu JEONG, Daejeon (KR); Taewon LEE, Namyangju-si (KR); Mi Jeong HAN, Daejeon (KR); In Taek HAN, Seoul (KR)

(21) Appl. No.: 15/273,898

(22) Filed: Sep. 23, 2016

(30) Foreign Application Priority Data
Sep. 24, 2015 (KR) 10-2015-0135887

(51) Int. Cl. H01B 1/24; C08B 16/00

(52) U.S. Cl. CPC H01B 1/24; C08B 16/00

(57) ABSTRACT

An electrically conductive composite including: a polymer matrix including a cellulose, and a plurality of electrically conductive carbon nanoparticles dispersed in the polymer matrix, wherein the electrically conductive carbon nanoparticles have a multiple hydrogen bonding moiety covalently bound to a surface thereof.

### CROSS-REFERENCE TO RELATED APPLICATION

This application claims priority to Korean Patent Application No. 10-2015-0135887, filed in the Korean Intellectual Property Office on Sep. 24, 2015, and all the benefits accruing therefrom under 35 U.S.C. §119, the content of which is incorporated herein in its entirety by reference.

### BACKGROUND

1. Field

Cellulose-based electrically conductive composites, compositions for preparing the same, and an electronic device including the same are disclosed.

2. Description of the Related Art

Research on application of a composite including an electrically conductive filler, for example, carbon nanotubes in a polymer matrix, to an electronic device, such as an actuator, has been actively pursued. Recently, application of this composite to a stretchable or wearable electronic device has been suggested. However, such composites lack sufficient electrical properties for use in an electronic device (e.g., low contact resistance and high electrical conductivity) and desirable mechanical properties (such as high tensile strength). Meanwhile, due to the growing concerns about the state of environment, advances have been made in using renewable natural substances as a polymer matrix. However, so far, no combination that includes an environmentally friendly substance and sufficiently miscible conductive fillers therefor has been reported. Thus, a need for natural source-based composites having desired electrical and mechanical properties still remains.

### SUMMARY

An embodiment provides an environmentally friendly and electrically conductive composite that includes renewable natural sources.

Another embodiment provides a composition providing the aforementioned electrically conductive composite.

Yet another embodiment provides an electronic device including the aforementioned electrically conductive composite.

In an embodiment, an electrically conductive composite includes:

a polymer matrix including a cellulose; and

a plurality of electrically conductive carbon nanoparticles dispersed in the polymer matrix,

wherein the electrically conductive carbon nanoparticles have a multiple hydrogen bonding moiety on a surface thereof.

The cellulose may include a regenerated cellulose.

The electrically conductive carbon nanoparticles may include a carbon nanotube, a graphene nanoparticle, a carbon nanofiber, carbon black, a carbonized nano-cellulose, or a combination thereof.

The multiple hydrogen bonding moiety may include at least two hydrogen-bonding sites.

The multiple hydrogen bonding moiety may include at least two moieties selected from a urea moiety, a pyridine moiety, a pyrimidine moiety, a pyrimidinone moiety, a triazine moiety, a purine moiety, an ether moiety, an amino moiety, an amide moiety, a naphthyridine moiety, and —CF₃.

The multiple hydrogen bonding moiety may include a moiety represented by any one of Chemical Formulae 1 to 4 or a derivative thereof:

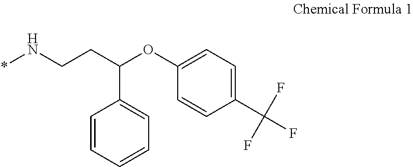 [SMILES: *NCCC(Oc1ccc(C(F)(F)F)cc1)c1ccccc1]

wherein * depicts linking to an adjacent atom;

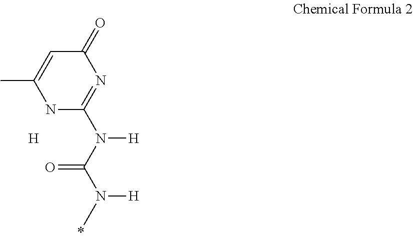

wherein * depicts linking to an adjacent atom;

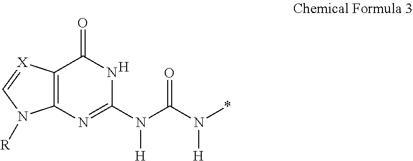

wherein

X is —CH═ or —N═,

R is H or a C1 to C10 alkyl, and

* depicts linking to an adjacent atom; and

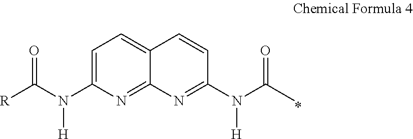

wherein

R is a substituted or unsubstituted C1 to C10 alkyl group or a substituted or unsubstituted C6 to C40 aryl group, and

* depicts linking to an adjacent atom.

The multiple hydrogen bonding moiety may be bonded to the electrically conductive particles via a linker derived from a diisocyanate group. An amount of the electrically conductive particles may be greater than or equal to about 0.5 percent by weight and less than or equal to about 60 percent by weight, based on the total weight of the electrically conductive composite.

The composite may be a fiber, a film, a fiber assembly, or a combination thereof.

The composite may be a composite fiber, and the composite fiber may have a tensile strength of greater than or equal to about 150 megaPascals and an initial modulus of greater than or equal to about 11 gigaPascals.

The composite may have electrical conductivity of greater than or equal to about 9×10⁻⁴ Siemens per meter.

In another embodiment, a composition for preparing an electrically conductive composite includes:

a cellulose;

an electrically conductive carbon nanoparticle having a multiple hydrogen bonding moiety on a surface thereof;

dimethyl acetamide; and

lithium chloride,

wherein the cellulose is dispersed in the composition without being precipitated.

The composition includes:

about 0.1 percent by weight to about 20 percent by weight of lithium chloride;

about 0.1 percent by weight to about 20 percent by weight of the cellulose;

about 0.01 percent by weight to about 30 percent by weight of the electrically conductive carbon nanoparticle; and

a balance of dimethylacetamide, based on the total weight of the composition.

The multiple hydrogen bonding moiety of the electrically conductive carbon nanoparticle may include at least two moieties selected from a urea moiety, a pyridine moiety, a pyrimidine moiety, a pyrimidinone moiety, a triazine moiety, a purine moiety, an ether moiety, an amino moiety, an amide moiety, a naphthyridine moiety, and —CF₃.

The multiple hydrogen bonding moiety may include a moiety represented by any one of Chemical Formulae 1 to 4 or a derivative thereof:

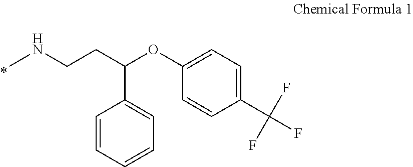 [SMILES: CNCCC(Oc1ccc(C(F)(F)F)cc1)c1ccccc1]

wherein * depicts linking to an adjacent atom;

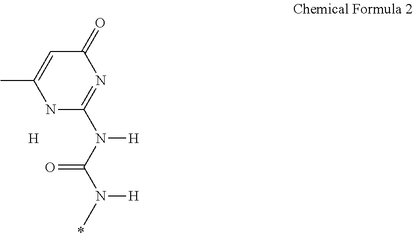

wherein * depicts linking to an adjacent atom;

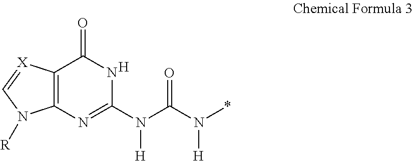

wherein

X is —CH═ or —N═,

R is H or a C1 to C10 alkyl, and

* depicts linking to an adjacent atom; and

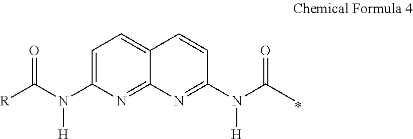

wherein

R is a substituted or unsubstituted C1 to C10 alkyl group or a substituted or unsubstituted C6 to C40 aryl group, and

* depicts linking to an adjacent atom.

In yet another embodiment, an electronic device including the electrically conductive composite is provided.

The electronic device may be a stretchable organic light emitting diode (OLED) display, a stretchable human motion sensor, a stretchable artificial muscle, a stretchable actuator, or a stretchable semiconductor. According to the embodiments, the electrically conductive composite is environmentally friendly as it may be prepared from a renewable natural source. In addition, the electrically conductive composite according to the embodiments may provide increased mechanical stability together with enhanced electrical conductivity, and may be transformed into various shapes such as a film or fiber. Therefore, the electrically conductive composite can be used as an electrically conductive member based on natural resources, or electrically heating members. In addition, the electrically conductive composite finds its utility in many fields such as wearable devices, batteries, EMI shielding materials, sensors, and the like.

### BRIEF DESCRIPTION OF THE DRAWINGS

The above and other advantages and features of this disclosure will become more apparent by describing exemplary embodiments thereof in further detail with reference to the accompanying drawings, in which:

FIG. 1 is a schematic view illustrating a hydrogen bonding interaction between the cellulose and the carbon nanotube having a quadruple hydrogen bonding moiety;

FIG. 2 is a schematic view illustrating a wet spinning process, according to an embodiment, conducted in the examples;

FIG. 3 is a photograph of a spinning dope prepared in the examples;

FIG. 4 is a graph of intensity (arbitrary units, a. u.) versus Raman shift (reverse centimeters, cm⁻¹), which is a Raman spectrum of the pristine multiwall carbon nanotube (hereinafter, MWCNT) and a multiwall carbon nanotube having quadruple hydrogen bonding moiety (hereinafter, MWCNT-MHB);

FIG. 5 is a graph of transmittance (arbitrary units, a. u.) versus wavenumber (reverse centimeters, cm⁻¹), which is an infra-red spectrum of a regenerated cellulose fiber and the composites that are prepared in the examples using different amounts of MWCNT-MHB;

FIGS. 6 to 10 are scanning electron microscope (SEM) images showing cross-sections of the cellulose fibers and the composite fibers that are prepared in the examples using different amounts of MWCNT-MHB, respectively;

FIG. 11A is a SEM image of the cross-section of the composite fiber including 30 percent by weight (wt %) of MWCNT-MHB, and FIG. 11B is an enlarged image thereof;

FIGS. 12 to 17 are microscope images of the surfaces of the cellulose fiber and the composite fibers that are prepared in the examples using different amounts of MWCNT-MHB, respectively;

FIG. 18 is a graph of stress (megaPascals, MPa) versus strain (percent, %), showing stress-strain curves of the cellulose fiber and the composites that are prepared in the examples using different amounts of MWCNT-MHB, respectively;

FIG. 19 is a graph of current (milliAmperes, mA) versus voltage (Volts, V), showing current-voltage curves of the cellulose fiber and the composites that are prepared in the examples using different amounts of MWCNT-MHB, respectively;

FIG. 20 is a graph of electric power (Watts, W) versus voltage (Volts, V), showing current-voltage curves of the cellulose fiber and the composites that are prepared in the examples using different amounts of MWCNT-MHB, respectively;

FIG. 21 is a graph of electrical conductivity (Siemens per centimeter, S/cm) versus amount of MWCNT-MHB (percent by weight, wt %), showing the changes of the conductivity as a function of the amount of MWCNT-MHB; and

FIG. 22 shows is a graph of a steady-state maximum temperature Tₘₐₓ (degree Centigrade, ° C.) versus voltage (Volts, V), illustrating the electrical heating behavior of the composite fibers each including different amounts of MWCNT-MHB.

### DETAILED DESCRIPTION

Exemplary embodiments will now be described more fully with reference to the accompanying drawings, in which some exemplary embodiments are shown. The exemplary embodiments, may, however, be embodied in many different forms and should not be construed as being limited to the embodiments set forth herein; rather, these exemplary embodiments are provided so that this disclosure will be thorough and complete, and will fully convey the scope of the exemplary embodiments of inventive concepts to those of ordinary skill in the art. Therefore, in some exemplary embodiments, well-known process technologies may not be explained in detail in order to avoid unnecessarily obscuring of aspects of the exemplary embodiments.

If not defined otherwise, all terms (including technical and scientific terms) in the specification may be defined as commonly understood by one skilled in the art. It will be further understood that terms such as those defined in commonly used dictionaries should be interpreted as having a meaning that is consistent with their meaning in the context of the relevant art and the present disclosure, and will not be interpreted in an idealized or overly formal sense unless expressly so defined herein. In addition, unless explicitly described to the contrary, the word “comprise” and variations such as “comprises” or “comprising” and “includes” or “including”, when used in this specification, will be understood to imply the inclusion of stated features, regions, integers, steps, operations, elements, and/or components, but do not preclude the presence or addition of one or more of other features, regions, integers, steps, operations, elements, components, and/or groups thereof. Further, the singular includes the plural unless mentioned otherwise. Thus, the singular forms “a,” “an,” and “the” are intended to include the plural forms, including “one or more,” unless the content clearly indicates otherwise. It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer or section. Thus, “a first element,” “component,” “region,” “layer,” or “section” discussed below could be termed a second element, component, region, layer, or section without departing from the teachings herein. The terminology used herein is for the purpose of describing particular embodiments only and is not intended to be limiting. “Or” means “and/or.” As used herein, the term “and/or” includes any and all combinations of one or more of the associated listed items. Further, “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations. Spatially relative terms such as “beneath,” “below,” “lower,” “above,” “upper”, and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Exemplary embodiments are described herein with reference to cross-sectional illustrations that are schematic illustrations of idealized embodiments. As such, variations from the shapes of the illustrations as a result of, for example, manufacturing techniques and/or tolerances, are to be expected. Thus, embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “hydrogen bonding” refers to a bond that occurs when a “donor” atom donates its covalently bonded hydrogen atom to an electronegative “acceptor” atom. For example, in a hydroxyl group (—OH) or a molecule of water (HOH) or in —NH₃⁺ or —NH—, the oxygen and the nitrogen atoms are typical donors. The lone electron pairs on the donor atoms may serve as H bond acceptors. As used herein, the term “regenerated cellulose” refers to a cellulose obtained from a solution that is prepared by dissolving a naturally occurring cellulose in a solvent. In some embodiments, the chemical structure of the regenerated cellulose does not substantially differ from the chemical structure of the naturally occurring cellulose. Alternatively, the regenerated cellulose may include a modified cellulose having a different chemical structure. As used herein, the term “substituted” refers to being substituted with at least one group selected from a C1 to C30 alkyl group, a C6 to C30 aryl group, a C7 to C30 arylalkyl group, a C1 to C30 alkoxy group, a C3 to C30 alicyclic group, a halogen, a hydroxyl group, and an amino group instead of hydrogen in a given moiety.

As used herein, when a definition is not otherwise provided, the term “alkyl group” refers to a group derived from a straight or branched chain saturated aliphatic hydrocarbon having the specified number of carbon atoms and having a valence of at least one.

As used herein, when a definition is not otherwise provided, the term “aryl”, which is used alone or in combination, refers to an aromatic hydrocarbon containing at least one ring and having the specified number of carbon atoms. The term “aryl” may be construed as including a group with an aromatic ring fused to at least one cycloalkyl ring.

As used herein, the term “alkylene group” refers to a straight or branched saturated aliphatic hydrocarbon group having a valence of at least two, optionally substituted with one or more substituents where indicated, provided that the valence of the alkylene group is not exceeded.

As used herein, when a definition is not otherwise provided, the term “arylene group” refers to a functional group having a valence of at least two obtained by removal of two hydrogens in an aromatic ring, optionally substituted with one or more substituents where indicated, provided that the valence of the alkylene group is not exceeded.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1-C30 alkyl” refers to a C1-C30 alkyl group substituted with C6-C30 aryl group, the total number of carbon atoms in the resulting aryl substituted alkyl group is C7-C60.

In an embodiment, an electrically conductive composite includes:

a polymer matrix including a cellulose; and

a plurality of electrically conductive carbon nanoparticles dispersed in the polymer matrix,

wherein the electrically conductive carbon nanoparticles have a multiple hydrogen bonding moiety on (e.g., covalently bound to and/or non-covalently bound to) a surface thereof.

In some embodiments, the cellulose may include regenerated cellulose, and in this case, the prepared composite may have the scanning microscope images shown in the examples set forth below. The cellulose is one of the well-known renewable natural resources, which is a long chain polymer of linearly linked sugar molecules. The cellulose may include a structural unit represented by the following formula.

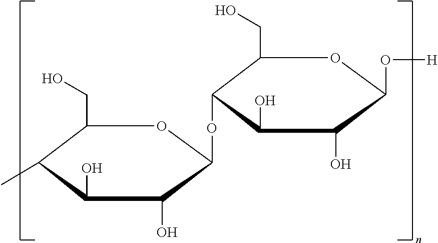

As used herein, the term “cellulose” refers to both cellulose having the aforementioned general formula, and derivatives thereof. As used herein, the term “cellulose derivative” refers to a cellulose, wherein at least one hydroxyl group of the aforementioned general formula is substituted with a substituent (e.g., —OS(═O)OH, —OC(═O)R, where R is a C1 to C3 alkyl group). In some embodiments, the cellulose derivative may have a substitution degree of less than or equal to about 2.3, for example, less than or equal to about 2.0, less than or equal to about 1.8, less than or equal to about 1.7, less than or equal to about 1.6, less than or equal to about 1.5, less than or equal to about 1.4, less than or equal to about 1.3, less than or equal to about 1.2, less than or equal to about 1.1, less than or equal to about 1.0, less than or equal to about 0.9, less than or equal to about 0.8, less than or equal to about 0.7, less than or equal to about 0.6, less than or equal to about 0.5, less than or equal to about 0.4, less than or equal to about 0.3, less than or equal to about 0.2, or less than or equal to about 0.1.

The amount of the polymer matrix including the cellulose may be greater than or equal to about 40 percent by weight (wt %) and less than or equal to about 99.5 wt %, based on the total weight of the electrically conductive composite.

The hydroxyl group of the cellulose chain may form a plurality of hydrogen bonds with other hydroxyl groups on adjacent chains, thereby bundling the chains together. The chains also pack regularly in places to form hard, stable crystalline regions that give the bundled chains even more stability and strength. Such high crystallinity and rigidity of the chains, however, make the production of the derivatives or the composites from the cellulose more difficult than from other synthetic polymers. In particular, the electrically conductive carbon nanoparticles have chemically inert surfaces and are hydrophobic. Therefore, it is very difficult for the cellulose (as one of the representative hydrophilic polymers) to form a composite with the carbon nanoparticles. In contrast, by using the compositions that will be set forth below, the electrically conductive carbon nanoparticles having the multiple hydrogen bonding moiety on their surfaces may be well dispersed in the cellulose matrix, and thereby the electrically conductive composite according to the embodiments may be prepared.

The electrically conductive composite according to the embodiments may exhibit enhanced mechanical properties (e.g., mechanical stability) and improved electrical conductivity. The electrically conductive carbon nanoparticles having the multiple hydrogen bonding moiety on their surfaces may exhibit an enhanced ability of interacting with the cellulose, and thus can be uniformly dispersed in the cellulose without using a dispersant. Moreover, it is believed that the electrically conductive carbon nanoparticles may effectively interconnect with each other to form a 3D network structure. Therefore, the composite including these carbon nanoparticles in the (e.g., regenerated) cellulose may exhibit enhanced electrical conductivity together with increased mechanical properties (e.g. stability). Without wishing to be bound by any theory, it is believed that unlike the conventional electrically conductive carbon nanoparticles or a COOH modified electrically conductive carbon nanoparticles, the electrically conductive carbon nanoparticles having the multiple hydrogen bonding moiety on their surfaces may form an intermolecular hydrogen bond with the cellulose, and thus may exhibit improved dispersibility without showing any substantial phase segregation.

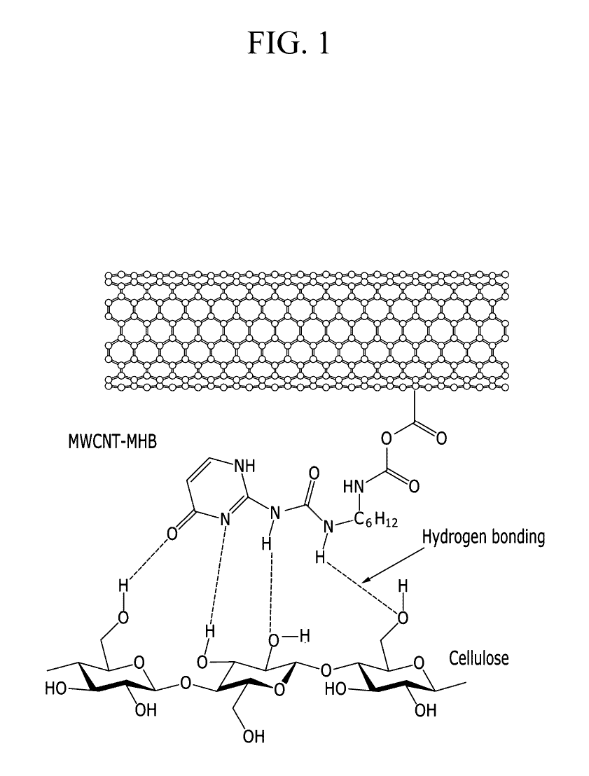

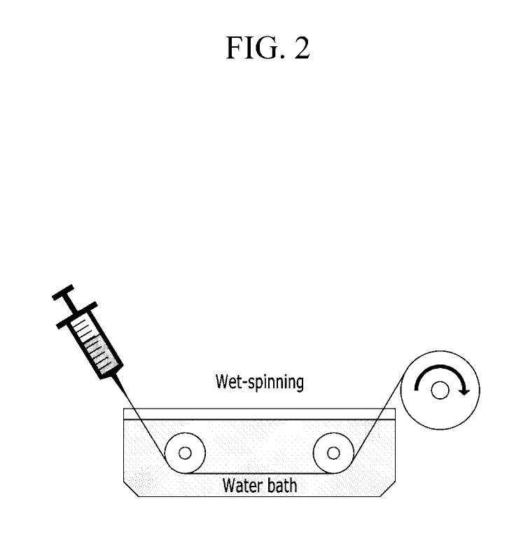

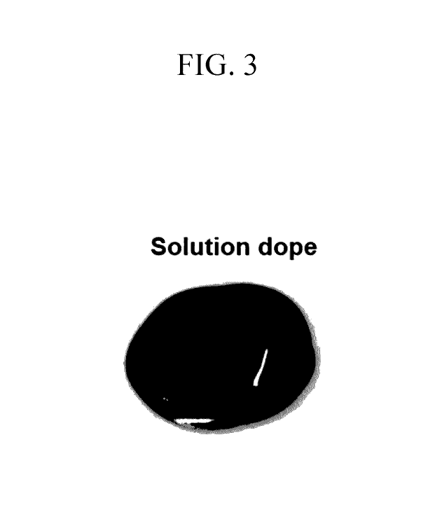

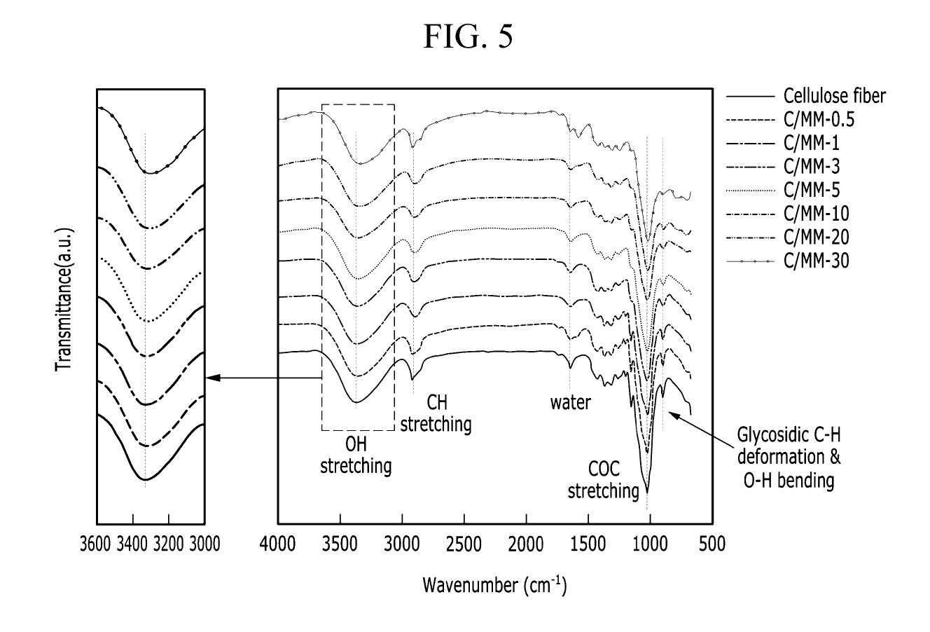

In non-limiting embodiments, referring to FIG. 1, the multiwall carbon nanotube having a quadruple hydrogen bonding moiety covalently bound to its surface may form a hydrogen bond with the hydroxyl group of the cellulose. For example, the Raman peak shift shown in FIG. 5 and the changes of the OH stretching determined from the results of FT-IR spectroscopy may corroborate the interaction with the hydrogen bonding moiety of the carbon nanotube. The electrically conductive carbon nanoparticles having a multiple hydrogen bonding moiety on their surface may be obtained by modifying the surface of the electrically conductive carbon nanoparticles.

The electrically conductive carbon nanoparticles may include a carbon nanotube, a graphene nanoparticle, a carbon nanofiber, carbon black, a carbonized nano-cellulose, or a combination thereof. As used herein, the term “electrically conductive carbon nanoparticle” refers to a particle that shows conductivity of about 10² Siemens per meter (S/m) or higher, has a diameter or a thickness of a nanoscale, and includes carbon as a main component. As used herein, the carbon nanotubes may include a carbon nanoparticle, a carbon nanofiber, a carbon nanorope, a carbon nanoribbon, a carbon nanofibril, a carbon nanoneedle, a carbon nanorod, a carbon nanocone, and the like. The carbon nanotubes may include a single-walled carbon nanotube (SWCNT), a double-walled carbon nanotube (DWCNT), a multi-walled carbon nanotube (MWCNT), or a combination thereof, but are not limited thereto. The dimensions of the carbon nanotubes are not particularly limited and may be selected appropriately. For example, the diameter of the carbon nanotube may be less than or equal to about 100 nanometers (nm), for example, less than or equal to about 50 nm, less than or equal to about 40 nm, less than or equal to about 30 nm, or less than or equal to about 20 nm, but is not limited thereto. The length of the carbon nanotube is not particularly limited, and may be greater than or equal to about 100 nm, for example, greater than or equal to about 1 micrometer (μm), greater than or equal to about 2 μm, or greater than or equal to about 3 μm, but it is not limited thereto. The length of the carbon nanotube may be less than or equal to about 1 millimeter (mm), for example, less than or equal to about 0.1 mm, less than or equal to about 100 μm, less than or equal to about 90 μm, less than or equal to about 80 μm, less than or equal to about 70 μm, less than or equal to about 60 μm, less than or equal to about 50 μm, less than or equal to about 40 μm, less than or equal to about 30 μm, or less than or equal to about 20 μm, but it is not limited thereto. The electrically conductive carbon nanoparticles may be commercially available, or may be synthesized by any suitable method (e.g., chemical vapor deposition, catalytic chemical vapor deposition, carbon catalytic vapor deposition, a high pressure carbon monoxide process, an arc discharging method, laser evaporation, and the like).

The multiple hydrogen bonding moiety may include at least two selected from a urea moiety, a pyridine moiety, a pyrimidine moiety, a pyrimidinone moiety, a triazine moiety, a purine moiety, an ether moiety, an amino moiety, an amide moiety, a naphthyridine moiety, and —CF₃. The multiple hydrogen bonding moiety may include a moiety represented by any one of Chemical Formulae 1 to 4, or a derivative thereof:

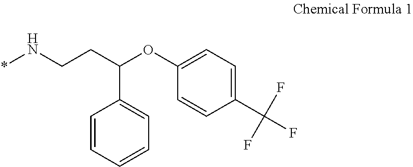 [SMILES: *NCCC(Oc1ccc(C(F)(F)F)cc1)c1ccccc1]

wherein * depicts linking to an adjacent atom;

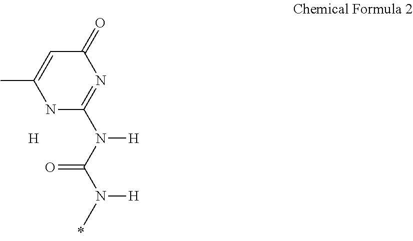

wherein * depicts linking to an adjacent atom;

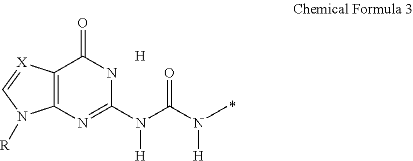

wherein

X is —CH═ or —N═,

R is H or a C1 to C10 alkyl, and

* depicts linking to an adjacent atom; and

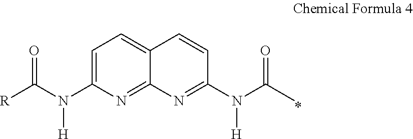

wherein

R is a substituted or unsubstituted C1 to C10 alkyl group or a substituted or unsubstituted C6 to C40 aryl group, and

* depicts linking to an adjacent atom.

In some embodiments, the multiple hydrogen bonding moiety may be bonded to the electrically conductive carbon nanoparticles via a linker derived from a diisocyanate compound. The diisocyanate compound may be a compound represented by Chemical Formula 5:

NCO—R—NCO Chemical Formula 5

wherein

R is a C1 to C20 alkylene group, a C6 to C40 arylene group, —Ar—NHCOO—[CH₂CHRO]ₙ—CONH—Ar— (in which Ar is the same or different and are each independently a substituted or unsubstituted arylene group, R is a C1 to C10 alkyl group, and n is 1 to 100).

By way of an example, the electrically conductive carbon nanoparticles having a multiple hydrogen bonding moiety may be prepared by:

introducing a carboxyl group onto a surface of an electrically conductive carbon nanoparticle; and

reacting the same with a compound having the multiple hydrogen bonding moiety and a diisocyanate compound (or a reaction product between the compound having the multiple hydrogen bonding moiety and the diisocyanate compound). The introduction of the carboxyl group onto the surface of the electrically conductive carbon nanoparticle is known in the art, and the electrically conductive carbon nanoparticles having the carboxyl group covalently bound to their surface are commercially available. For example, the introduction of the carboxyl group onto the surface of the electrically conductive carbon nanoparticles may be carried out by treating the carbon nanoparticles with sulfuric acid, nitric acid, or a combination (for example, mixture) thereof, but it is not limited thereto. The diisocyanate compound may react with a reactive group (e.g., an amine group or a hydroxyl group) present in the compound having the multiple hydrogen bonding moiety, and may also react with the carboxyl group on the electrically conductive carbon nanoparticle. The diisocyanate compound may include hexamethylene diisocyanate, toluene diisocyanate, or a toluene diisocyanate terminated polypropylene glycol. The toluene diisocyanate terminated polypropylene glycol may include toluene 2,4-diisocyanate terminated polypropylene glycol having a number average molecular weight of about 100 to 5,000 (e.g., about 500 to 3,000). The reaction conditions for introducing the multiple hydrogen bonding moiety onto the electrically conductive nanoparticles may be selected taking into account the nature of the reactants. For example, the reaction may be carried out under a nitrogen atmosphere at a temperature of about 90° C. or higher for about 10 minutes (min) or longer, but it is not limited thereto. In non-limiting examples, reacting the diisocyanate compound with the compound having the multiple hydrogen bonding moiety may be carried out, for example, under a nitrogen atmosphere at a temperature of about 90° C. or higher for a predetermined time. The reaction product between the diisocyanate compound and the compound having the multiple hydrogen bonding moiety may then be in contact with a dispersion including the carbon nanoparticles having the carboxyl groups covalently bound to their surfaces and an organic solvent at a predetermined temperature (e.g., at a temperature of about 90° C. or higher) for a predetermined time (e.g., for about 10 min or longer, or about one hour or longer) to provide the carbon nanoparticles having the multiple hydrogen bonding moieties covalently bound to their surfaces. The amount of the multiple hydrogen bonding moiety may be selected appropriately and is not particularly limited. In the composites of the aforementioned embodiments, the amount of the electrically conductive carbon nanoparticles having the multiple hydrogen bonding moiety covalently bound to its surface may be selected appropriately taking into consideration a desired level of the electrical conductivity and the mechanical properties of the composite. In some embodiments, the amount of the electrically conductive carbon nanoparticles having the multiple hydrogen bonding moiety on their surface may be greater than or equal to about 0.1 wt %, for example, greater than or equal to about 0.5 wt %, greater than or equal to about 1.0 wt %, greater than or equal to about 2.0 wt %, greater than or equal to about 3.0 wt %, greater than or equal to about 4.0 wt %, greater than or equal to about 5.0 wt %, greater than or equal to about 6.0 wt %, greater than or equal to about 7.0 wt %, greater than or equal to about 8.0 wt %, greater than or equal to about 9.0 wt %, greater than or equal to about 10.0 wt %, greater than or equal to about 15 wt %, greater than or equal to about 20 wt %, or greater than or equal to about 25 wt %, based on the total weight of the electrically conductive composite. The composites may exhibit an increased level of electrical conductivity. The conductivity of the composites may be greater than or equal to about 9×10⁻⁴ S/cm, for example, greater than or equal to about 8×10⁻³ S/cm, greater than or equal to about 4×10⁻² S/cm, greater than or equal to about 1×10⁻² S/cm, or even greater than or equal to about 1 S/cm. The composites may be processed to have a form of a fiber, a film, a fiber assembly, or a combination thereof. For example, the composite may have a form of a fiber, a film, a fiber assembly such as various textiles (e.g., a woven fabric, a non-woven fabric, and the like), or a combination thereof. The composite may have a multi-layered structure. In some embodiments, the composite may be in the form of a fiber (hereinafter, “composite fiber”), and the composite fiber may have tensile strength of greater than or equal to about 150 megaPascals (MPa), for example, greater than or equal to about 155 MPa, greater than or equal to about 160 MPa, greater than or equal to about 165 MPa, greater than or equal to about 170 MPa, greater than or equal to about 180 MPa, or greater than or equal to about 200 MPa. The composite fibers thus prepared may have an initial modulus of greater than or equal to about 11 gigaPascals (GPa), for example, greater than or equal to about 12 GPa. The composite fibers thus prepared may have elongation at rupture of about 3% or higher, for example, 3.5% or higher, 4% or higher, 4.5% or higher, 5% or higher, or 5.5% or higher.

In some embodiments, the composition for preparing the aforementioned electrically conductive composite may include:

a cellulose;

a plurality of electrically conductive carbon nanoparticle having a multiple hydrogen bonding moiety covalently bound to a surface thereof;

dimethyl acetamide; and

lithium chloride.

The cellulose may be dissolved in the composition.

The composition may include:

about 0.1 wt % to about 20 wt %, for example, about 1 wt % to about 10 wt % of lithium chloride;

about 0.1 wt % to about 20 wt %, for example, about 0.5 wt % to about 15 wt % of the cellulose;

about 0.01 wt % to about 30 wt %, for example, about 1 wt % to about 20 wt % of the electrically conductive carbon nanoparticle; and

a balance of dimethylacetamide, based on the total weight of the composition. In some embodiments, the composition does not include water. Details of the cellulose and the electrically conductive carbon nanoparticle having a multiple hydrogen bonding moiety are the same as set forth above.

The aforementioned composition may be prepared in the following manner. First, a lithium chloride (LiCl) solution in dimethylacetate (DMAc) having a certain concentration is prepared. The cellulose or a derivative thereof is dissolved in the prepared LiCl solution to have a predetermined concentration (e.g., about 0.1 wt % to about 40 wt %) to obtain a first solution. The electrically conductive carbon nanoparticle having a multiple hydrogen bonding moiety is dispersed in DMAc at a predetermined concentration to provide a second solution. The first solution and the second solution are then mixed to provide a composition that includes the aforementioned components at the aforementioned amounts. In the composition thus obtained, the cellulose or a derivative thereof may be present in a dissolved state, and the electrically conductive carbon nanoparticles may be dispersed therein without causing any substantial precipitation. The composition may be used as a spinning dope to provide a composite fiber. In other embodiments, the aforementioned composition may provide a staple fiber, for example, via electro-spinning. In some embodiments, the composite fiber may be prepared by using the composition as a spinning dope in a dry spinning or wet spinning process. For example, the composite fiber may be prepared by preparing the aforementioned composition as a spinning dope, discharge the spinning dope through a spinneret into a coagulation medium at room temperature, and taking out and winding the resulting product. The coagulation medium may include water, a C1 to C3 alcohol, or a mixture thereof. The detailed conditions for the wet spinning process such as a diameter of a spinneret, a spinning rate, and a winding speed may be selected appropriately and are not particularly limited. For example, the spinning rate may be between about 0.1 milliliters per minute (mL/min) and about 1 mL/min, but it is not limited thereto. The diameter of the spinning nozzle may be between 0.01 mm and 0.5 mm, but it is not limited thereto. The winding speed of the wet spun fiber may be between about 1 centimeters per minute (cm/min) and about 100 cm/min, but it is not limited thereto. The wound fiber may be dried at a predetermined temperature (e.g., room temperature, for example, about 25° C. to about 80° C., for example, about 40° C. to about 70° C.) for a predetermined time (e.g., for about 10 min or longer, about 30 min or longer, about 1 h or longer, or about 10 h or longer), but it is not limited thereto. In other embodiments, the composite may be prepared as a film. For example, the film may be prepared by applying the composition on to a support via a film casting or spin coating process and drying the same.

According to another embodiment, an electronic device including the aforementioned electrically conductive composite is provided. For example, the electronic device may be various displays, wearable devices, batteries, a stretchable organic light emitting diode (OLED) display, a stretchable human motion sensor, a stretchable artificial muscle, stretchable actuator, or a stretchable semiconductor.

Hereinafter, the embodiments are illustrated in more detail with reference to examples. These examples, however, are not in any sense to be interpreted as limiting the scope of this disclosure.

### EXAMPLES

### 1. Materials

Cellulose powder with a particle size of 50 micrometers (μm) was supplied from Sigma-Aldrich., Ltd. Pristine MWCNT (CM-250, diameter of 10-15 μm, length of ˜15 μm, and bulk density of ˜0.02 grams per cubic centimeter, g/cm³) was purchased from Hanwha Chemical Co., Ltd. N,N-dimethylacetamide (DMAc, 99.5%, Samchun Pure Chemical Co., Ltd.) and lithium chloride (LiCl, anhydrous, 98.2%, Samchun Pure Chemical Co., Ltd.) were used to dissolve the cellulose powder. 2-amino-4-hydroxy-6-methylpyrimidine, hexamethylene diisocyanate, and 1,1,1,3,3,3-hexafluoro-2-propanol were purchased from Sigma-Aldrich Co. All the materials and chemicals were used as received.

### 2. Preparation of Multiwall Carbon Nanotubes Having a Multiple Hydrogen Bonding Moiety on their Surface

To manufacture MWCNT-MHB, carboxylic acid-functionalized MWCNTs (MWCNT-COOH) were obtained by treating pristine MWCNTs with a mixture of sulfuric acid and nitric acid (3:1 by volume ratio) at 50 degrees Centigrade (° C.) for 24 hours (h). After that, MWCNT-COOHs were filtered and washed with distilled water, and the washing was repeated until the solution reached pH 7. MWCNT-COOHs were then dried in a vacuum oven at 70° C. for 24 h. A solution of 2-amino-4-hydroxy-6-methylpyrimidine (1 equivalent, eq.) in hexamethylene diisocyanate (10 eq.) was heated at 100° C. in a N₂ atmosphere. After 16 h, the reaction mixture was precipitated using n-hexane. Filtration and washing of the residue with n-hexane and subsequent drying of the solid gave the pure product. A solution of MWCNT-COOH in DMF was dispersed by bath sonication. Upy-NCO (hexyl-NCO) was added to the solution at 100° C. under a N₂ atmosphere. The weight ratio of the MWCNT-COOH and hexyl-NCO was 1:0.25. After 18 h, the reaction mixture was filtered and washed by DMF and chloroform. Then, MWCNT-MHBs were dried in a vacuum oven at 70° C. for 24 h.

### 3. Preparation of Composite Fibers

Regenerated cellulose/MWCNT-MHB composite fibers were manufactured by facile wet-spinning, as can be seen in the schematic illustration of FIG. 1. First, a transparent cellulose solution was prepared by dissolving cellulose powder (5.0 percent by weight, wt %) into DMAc/LiCl (86/9 by weight ratio) and heating at 110° C. for 24 h. Second, predetermined amounts of MWCNT-MHB were added in DMAc to obtain 2.5-3.0 wt % solutions. Third, each MWCNT-MHB solution was mixed with the cellulose solution and stirred for 30 minutes (min) at 50° C. Subsequently, the mixed solutions were sonicated for 2 h with a bath-type ultrasonicator (50-60 Hertz, Hz), stirred for 40 h at room temperature, and sonicated again for 1 h. Fourth, the cellulose/MWCNT-MHB solution dopes were spun into a water bath at room temperature at a speed of 0.3 milliliters per minute (mL/min) through a spinneret needle with an inner diameter of 0.41 millimeters (mm). The take-up speed of wet-spun fibers was controlled to be ˜125 centimeters per minute (cm/min). After wet-spinning and take-up, the composite fibers were dried at 60° C. for 24 h. Finally, the cellulose/MWCNT-MHB composite fibers were immersed in a water bath for 12 h and then dried in a vacuum oven at 70° C. for 12 h. The MWCNT-MHB contents in the composite fibers were 0.5, 1.0, 3.0, 5.0, 10.0, 20.0, and 30.0 wt %. The final composite fibers were called C/MM-x, where x denotes the MWCNT-MHB content by wt %. For comparison, a neat cellulose fiber was also prepared with the same procedure.

### 4. Characterization

The structural features of the pristine MWCNT and MWCNT-MHB were investigated by a high resolution Raman Spectrometer (LabRAM HR-800 UV-Visible-NIR, Horiba Jobin Yvon). The molecular structure of the neat cellulose and its composite fibers with different MWCNT-MHB contents was identified by using a microscope infrared spectrometer (iN10, Nicolet). The dispersion state of the MWCNT-MHB in the composite fibers was characterized with the aid of a cold-type field emission scanning electron microscope (SEM, S-4800, Hitachi). The tensile mechanical properties of the composite fibers were examined by using a universal tensile machine (INSTRON, 4467) with an extension rate of 8 millimeters per minute (mm/min) at room temperature. The electrical properties of the composite fibers were investigated by obtaining current-voltage (I-V) and electric power-voltage (P-V) curves with multiple electrometers (2400, 6517B, Keithley Instruments Inc.). For the electrical experiments, the electrode distance of the composite fibers was set to be 10.0 mm. The electric heating behavior of the composite fibers was characterized with an infrared camera (SE/A325, FLIR Systems) and a SourceMeter (model 2400, Keithley Instruments Inc.).

### 5-1. Structural Characterization

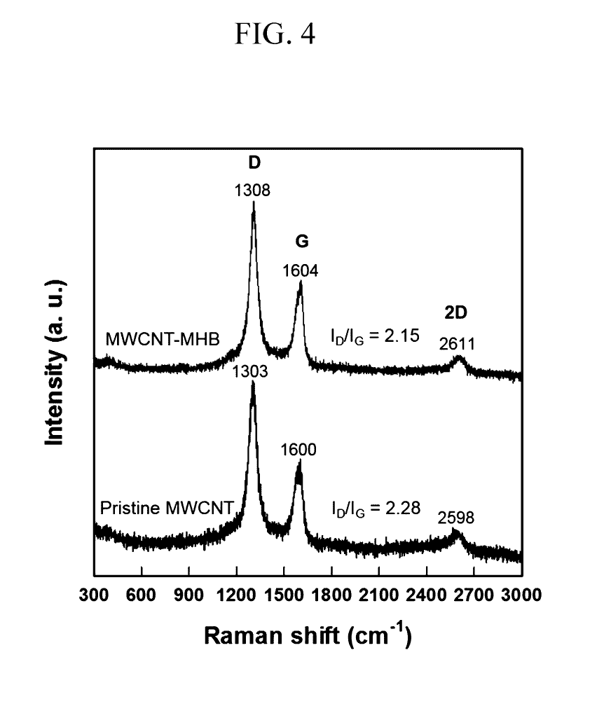

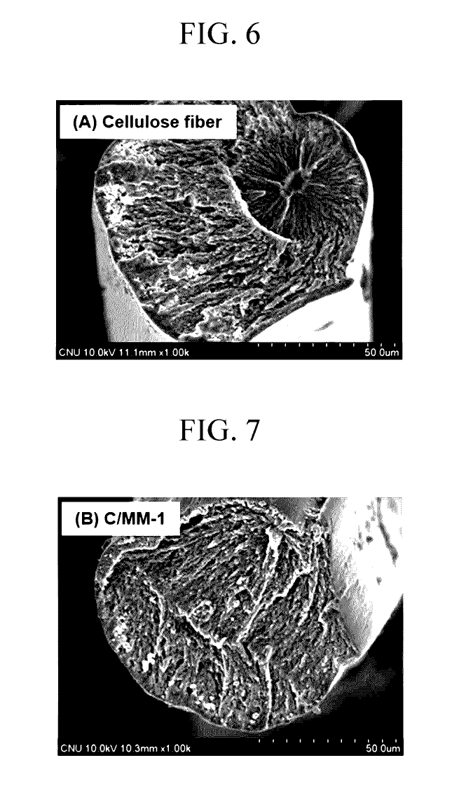

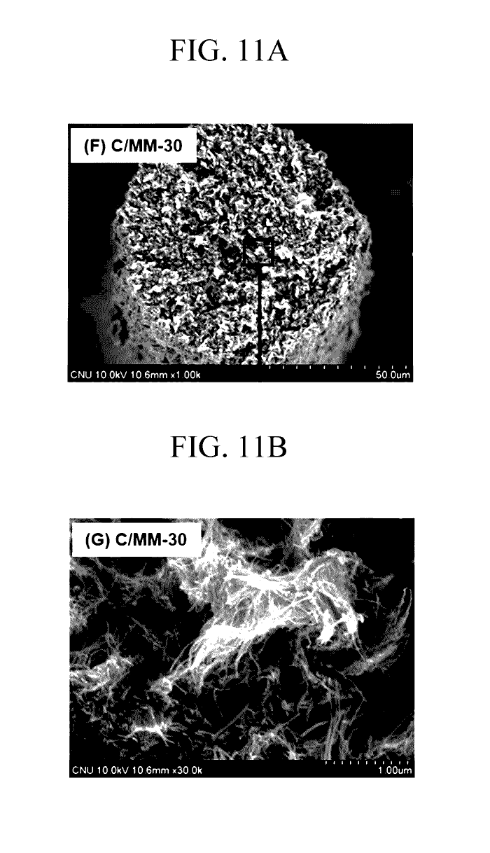

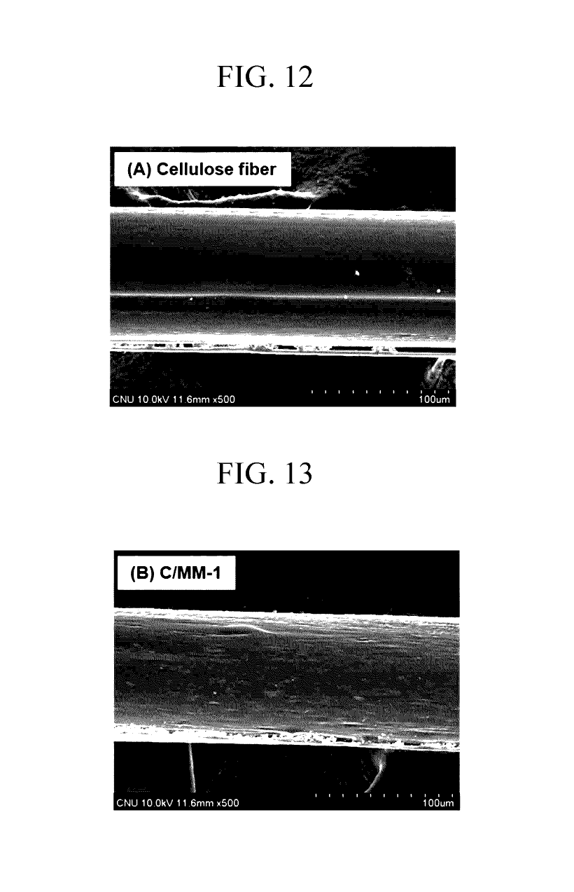

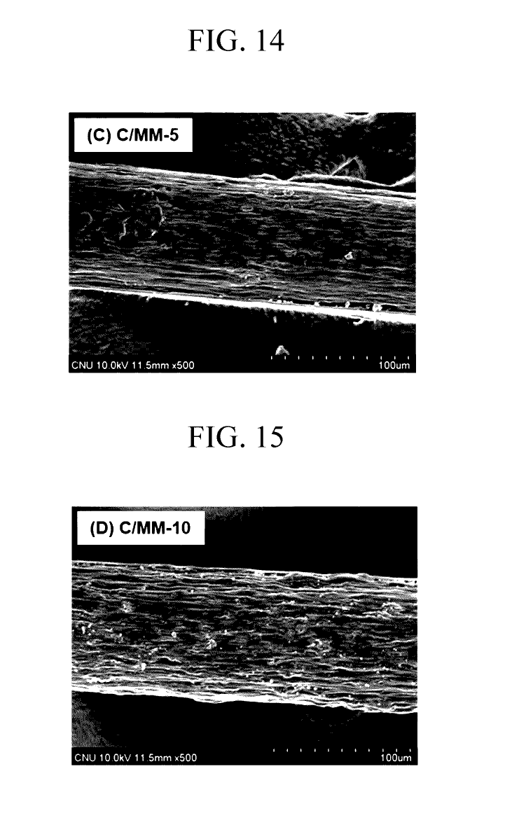

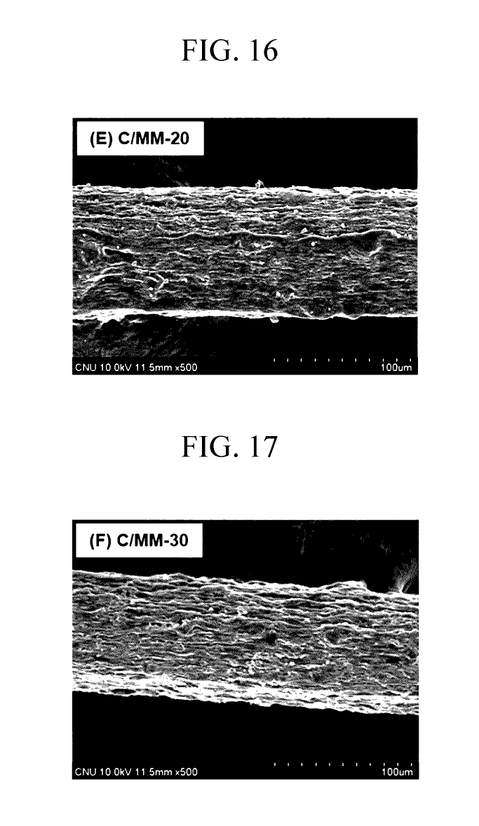

FIG. 4 shows Raman spectra of the pristine MWCNT and MWCNT-MHB that is modified to have quadruple hydrogen bonding moiety covalently bound to its surface. The Raman spectrum of the pristine MWCNT typically exhibits D, G, and 2D bands at 1303 reverse centimeters (cm⁻¹), 1600 cm⁻¹, and 2598 cm⁻¹, respectively. The G band is associated with the in-plane stretching vibrations of the carbon-carbon bonds in graphene layers, the D band originates from the structural imperfection of the MWCNT, and the 2D band is attributed to the overtone of the D band. In case of the MWCNT-MHB, characteristic D, G, and 2D bands were detected at 1308 cm⁻¹, 1604 cm⁻¹, and 2611 cm⁻¹, respectively, which were detected at higher wavenumbers compared with the pristine MWCNT, owing to the presence of hydrogen bond interaction among MWCNT-MHBs. When the relative intensity ratio of the D and G bands (I_{D}/I_{G}) was evaluated as a measure of defects of the pristine and modified MWCNTs, it was found that the I_{D}/I_{G} value of ˜2.28 for the pristine MWCNT decreased slightly to ˜2.15 for the MWCNT-MHB. This demonstrates that the impurities or defects existing in the pristine MWCNT were slightly removed by the chemical modification process for manufacturing the MWCNT-MHB. In order to identify the specific interaction between MWCNT-MHB and cellulose, infrared spectra of the cellulose fiber and its composite fibers were obtained as shown in FIG. 5. For the cellulose fiber, characteristic vibrational bands were observed at ˜3379 cm⁻¹, ˜2920 cm⁻¹, ˜1647 cm⁻¹, ˜1022 cm⁻¹, and ˜902 cm⁻¹, which are assigned to O—H stretching, C—H stretching, water in amorphous region, C—O—C stretching, and glycosidic C—H deformation/O—H bending, respectively. It is noteworthy that the —OH stretching bands shifted continuously with the increment of MWCNT-MHB content from 3379 cm⁻¹ for the regenerated cellulose to 3337 cm⁻¹ for the composite fiber with 30 wt % MWCNT-MHB. This difference in the position of the absorption bands stems from the existence of the hydrogen bonding interaction between —OH groups of the cellulose backbone and chemically modified functional groups of MWCNT-MHB. To characterize the dispersion state of the MWCNT-MHB in the composite fibers, SEM images of the cross-sectional view of the fractured cellulose fiber and composite fibers with different MWCNT-MHB contents are presented in FIGS. 6 to 10 and FIGS. 11a and 11b, respectively. For the neat cellulose fiber, a relatively smooth and clean surface was observed without showing any micropores, which indicates that the wet-spinning process used in these examples was well conditioned for manufacturing the fibers. In cases of the composite fibers, the cross-sectional surface was rougher with the increment of the MWCNT-MHB content, although the MWCNT-MHB was uniformly dispersed in the cellulose matrix. SEM images of the longitudinal view for the neat cellulose fiber and composite fibers are displayed in FIGS. 12 to 17. For the neat cellulose fiber, the longitudinal surface was also very clean and smooth without any morphological defects. In cases of the composite fibers, the longitudinal surface became rough with the increase of the MWCNT-MHB loading.

### 5-2. Mechanical Properties of the Composite

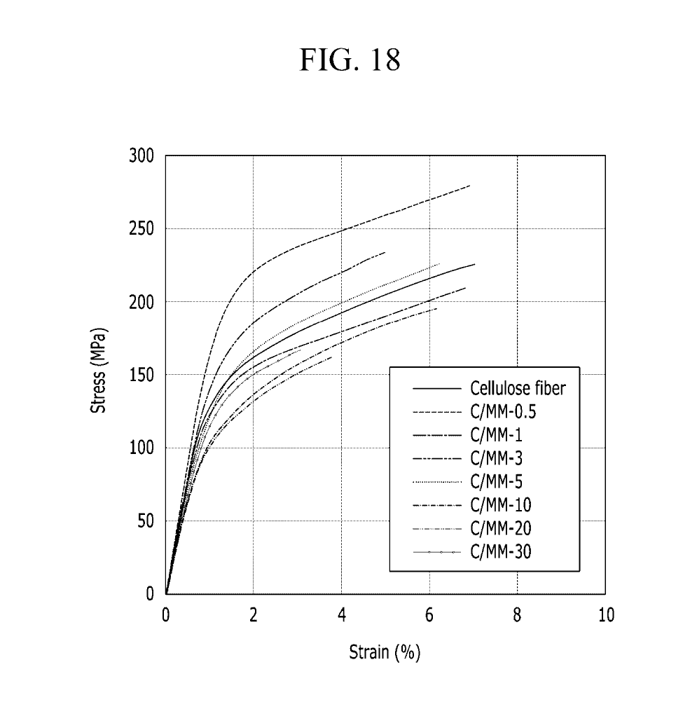

The tensile mechanical tests of the cellulose composite fibers with different MWCNT-MHB contents were carried out at room temperature, as can be seen in the stress-strain curves depicted in FIG. 18. As the results, the tensile strength, strain to break, and initial modulus are summarized in Table 1.

TABLE 1

| | Tensile strength | Strain to break | Initial modulus |
|---|---|---|---|
| Sample code | (MPa) | (%) | (GPa) |
| Cellulose fiber | 229.5 ± 11.6 | 7.0 ± 1.0 | 13.1 ± 2.0 |
| C/MM-0.5 | 278.4 ± 24.9 | 5.7 ± 0.8 | 13.9 ± 1.9 |
| C/MM-1 | 214.0 ± 22.7 | 6.2 ± 1.7 | 12.3 ± 0.9 |
| C/MM-3 | 227.0 ± 10.4 | 4.7 ± 0.1 | 14.9 ± 2.0 |
| C/MM-5 | 224.4 ± 20.2 | 5.2 ± 1.3 | 12.5 ± 2.7 |
| C/MM-10 | 194.3 ± 17.6 | 5.3 ± 0.9 | 11.3 ± 2.4 |
| C/MM-20 | 164.7 ± 3.5 | 4.7 ± 1.0 | 12.0 ± 1.1 |
| C/MM-30 | 155.9 ± 19.7 | 3.7 ± 0.4 | 12.5 ± 0.9 |

The neat cellulose fiber was found to have tensile strength of ˜229.5 megaPascals (MPa), strain to break of ˜7.0%, and initial modulus of ˜13.1 gigaPascals (GPa). For the composite fiber with 0.5 wt % MWCNT-MHB, higher tensile strength and initial modulus except for the strain to break were attained, compared to the neat cellulose fiber, which stems from the reinforcing effect of the MWCNT-MHB. In addition, the composite fibers with 1.0-5.0 wt % MWCNT-MHB have relatively high tensile strength and initial moduli, which are comparable with the neat cellulose fiber. However, in cases of the composite fibers with high MWCNT-MHB contents of 10-30 wt %, tensile strength and strain to break decreased slightly with the increase of the MWCNT-MHB content. Nonetheless, it is noticeable that the mechanical properties of the composite fiber with 30.0 wt % MWCNT-MHB such as tensile strength of ˜156 MPa, strain to break of ˜3.7%, and initial modulus of ˜12.5 GPa were high enough to be used for a variety of practical applications.

5.3. Electrical Property

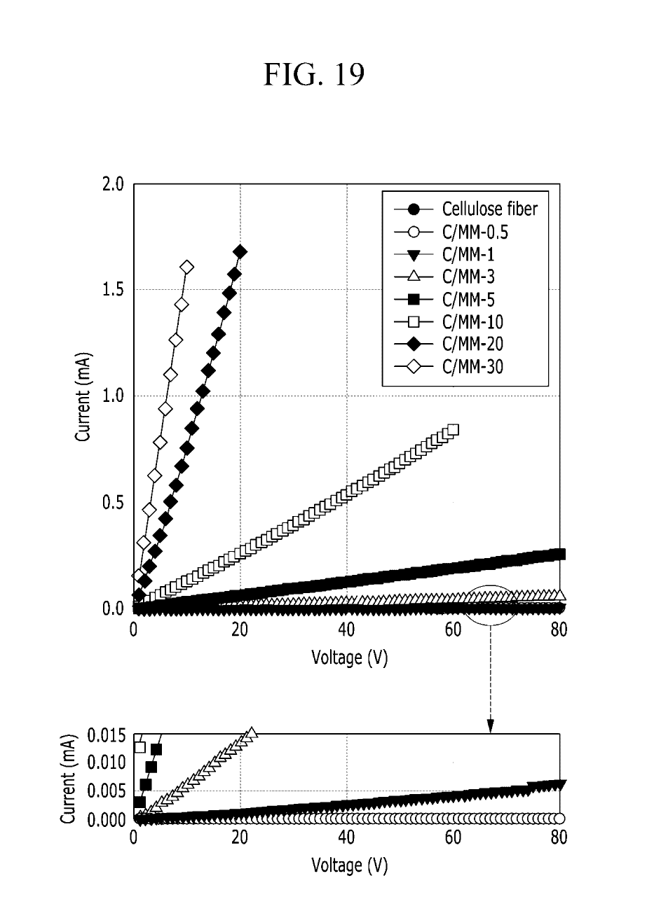

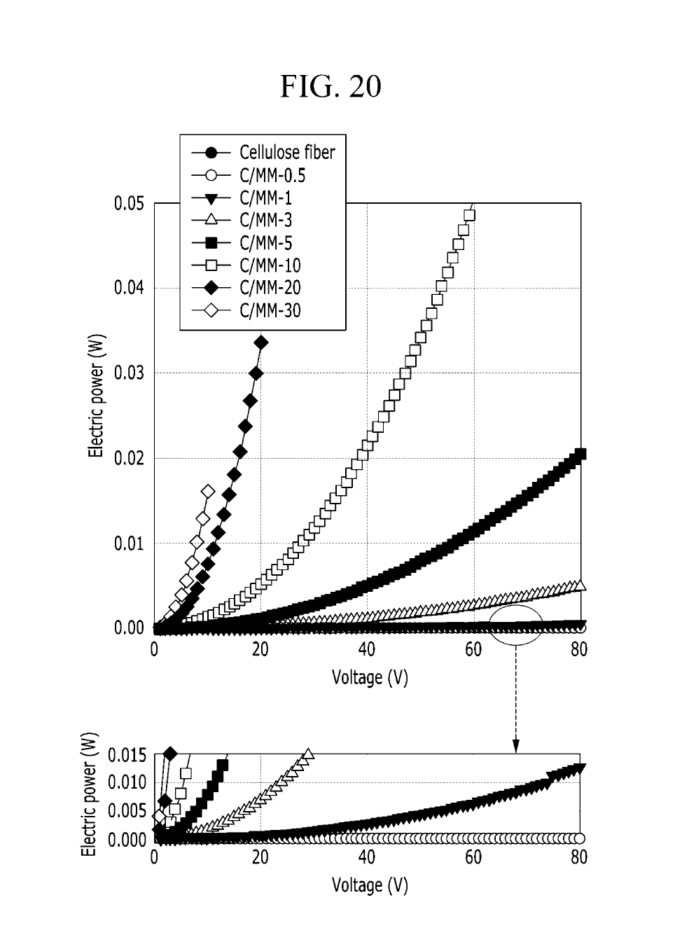

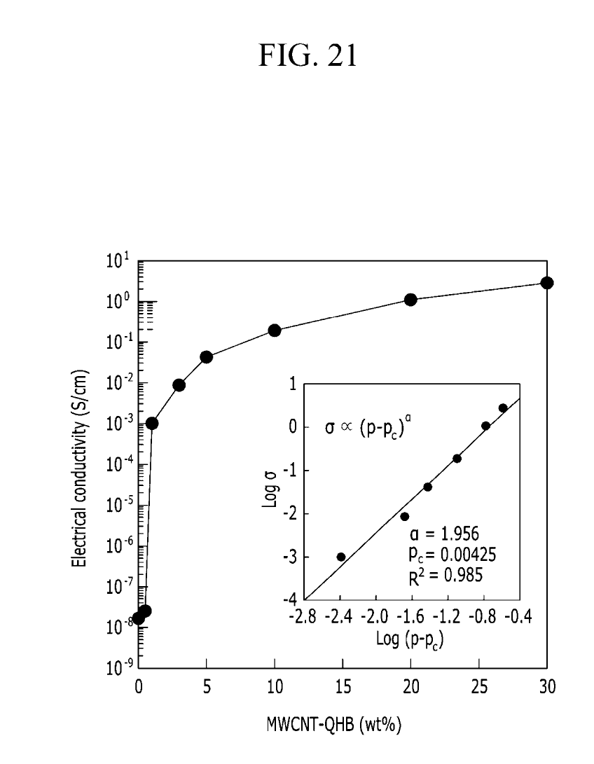

The current-voltage (I-V) curves of the cellulose composite fibers with different MWCNT-MHB contents are shown in FIG. 19. For the neat cellulose fiber and its composite fibers with 0.5 wt % MWCNT-MHB, there was almost no electric current over the applied voltage of 1-80 Volts (V). On the other hand, in cases of the composite fibers with >1.0 wt % MWCNT-MHB contents, the electric current increased linearly with the applied voltage and the slopes of the I-V curves increased significantly with the MWCNT-MHB content in the composite fibers. This demonstrates that the MWCNT-MHBs are physically connected to each other in the cellulose matrix and the networking degree was strengthened with the increment of MWCNT-MHB content. FIG. 20 presents the electric power-voltage (P-V) curves of the cellulose-based composite fibers. It was found that the electric power of the composite fibers with >1.0 wt % MWCNT-MHB was quadratically proportional to the applied voltage, which is consistent with the expression P=IV=V²R. FIG. 21 shows the changes of electrical conductivity of the composite fibers as a function of the MWCNT-MHB content. The electrical conductivity of the neat cellulose fiber and the composite fiber with 0.5 wt % MWCNT-MHB was measured to be ˜10⁻⁸ Siemens per centimeter (S/cm), indicating that the fibers are electrically insulating. This means that the electric charges do not flow effectively in the composite fiber because of no physical network among MWCNT-MHBs in the cellulose matrix. The electrical resistivity and the electrical conductivity for each of the prepared composites are compiled in Table 2.

TABLE 2

| | Electrical | Electrical |
|---|---|---|
| | resistivity | conductivity |
| Sample code | (Ωcm) | (S/cm) |
| Cellulose fiber | 6.22 × 10⁷ | 1.61 × 10⁻⁸ |
| MWCNT-QHB5/C-0.5/99.5 | 4.15 × 10⁷ | 2.41 × 10⁻⁸ |
| MWCNT-QHB5/C-1/99 | 1.02 × 10³ | 9.77 × 10⁻⁴ |
| MWCNT-QHB5/C-3/97 | 1.20 × 10² | 8.36 × 10⁻³ |
| MWCNT-QHB5/C-5/95 | 2.47 × 10¹ | 4.05 × 10⁻² |
| MWCNT-QHB5/C-10/90 | 5.47 × 10⁰ | 1.83 × 10⁻¹ |
| MWCNT-QHB5/C-20/80 | 9.53 × 10⁻¹ | 1.05 × 10⁰ |
| MWCNT-QHB5/C-30/70 | 3.70 × 10⁻¹ | 2.70 × 10⁰ |

On the other hand, as the MWCNT-MHB content increases, the electrical conductivity was found to increase significantly from 2.4×10⁻⁸ S/cm for the composite fiber with 0.5 wt % MWCNT-MHB to 9.8×10⁻⁴ S/cm for the composite fiber with 1.0 wt % MWCNT-MHB to 2.7 S/cm for the composite fiber with 30.0 wt % MWCNT-MHB. The dramatic increase of the electrical conductivity with the MWCNT-MHB content is believed to be owing to the formation of interconnected networks of MWCNT-MHBs in the composite fibers. To evaluate the electrical percolation threshold, the following power law relation was adopted:

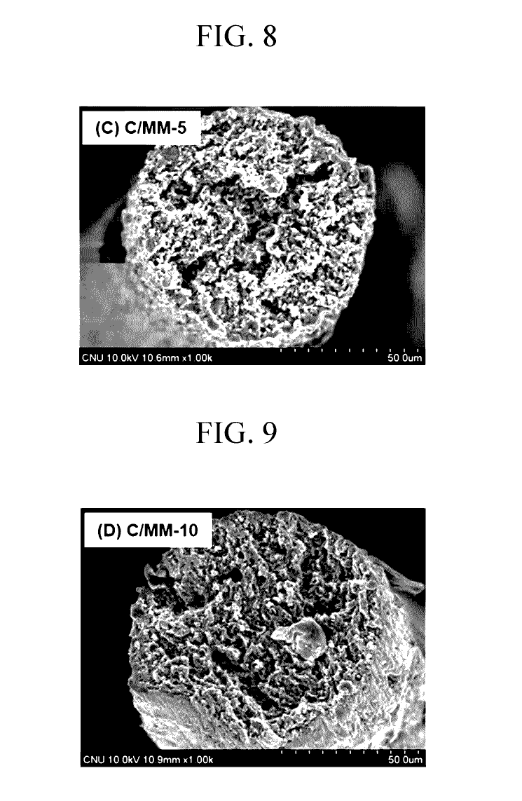

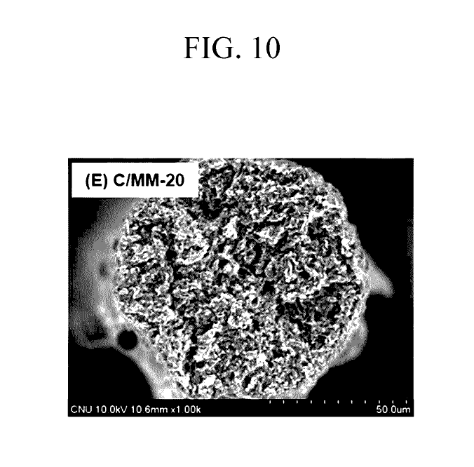

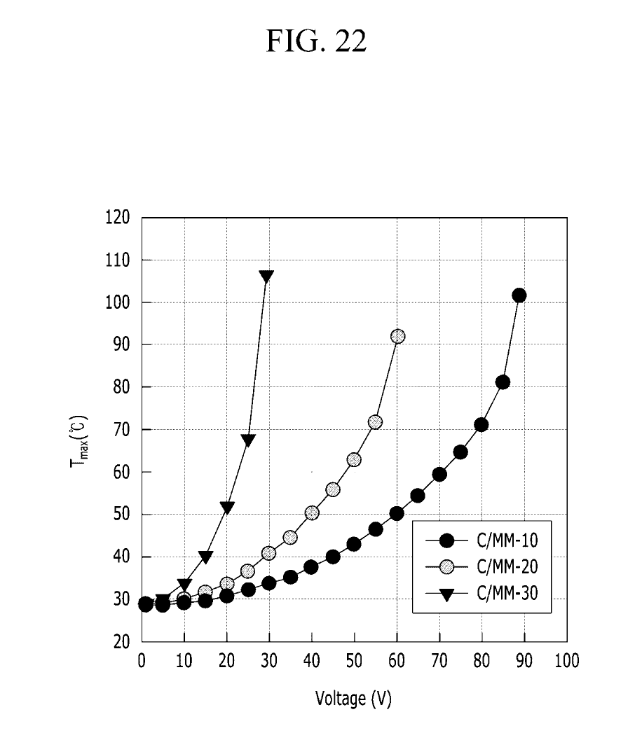

σ∝(p−p_{c})^{α}

where σ is the electrical conductivity, p is the MWCNT volume fraction, p_{c} is the critical volume fraction at electrical percolation, and α is the critical exponent. The straight line with p_{c}=0.00425 (˜0.52 wt %) and α=1.956 gives a good fit to the experimental data of a log σ vs. log(p−p_{c}) plot, as shown in the inset of FIG. 9A. Theoretically, the critical exponent as an index of the conductive particle-dispersed system dimensionality has been predicted to be 1.3 and 1.94 for ideal 2-D and 3-D systems, respectively. Therefore, the α value of 1.956 for the cellulose/MWCNT-MHB composite fibers indicates that the MWCNT-MHBs form a quasi-3-D network at a critical percolation threshold of ˜0.52 wt %. It is thus speculated that the low p_{c} value arises from the uniform dispersion of MWCNT-MHBs in the cellulose matrix. In addition, for the composite fiber with 30.0 wt % MWCNT-MHB, high electrical conductivity of ˜10° S/cm can be achieved. As a result, when the composite fiber is applied as a conductive cable, a light-emitting diode (LED) lamp can be lit at the applied voltage of 3 V. The electric heating behavior of the conductive and strong cellulose composite fibers with high MWCNT-MHB contents of 10.0-30.0 wt % was investigated by varying applied voltages. When constant voltages above a critical value were applied to the composite fibers with 10.0-30.0 wt % MWCNT-MHB, the temperatures increased rapidly to a certain steady-state value. The electric heating behavior of the composite fibers was confirmed by typical digital and infrared images, as shown in FIG. 10A. For the composite fibers with 10.0-30.0 wt % MWCNT-MHBs, the steady-state maximum temperatures (Tₘₐₓ) attained at constant applied voltages are presented in FIG. 22. The Tₘₐₓ values of the composite fibers were found to be increased quadratically in the second function over the applied voltage, which is consistent with the electric-power-voltage curves in FIG. 8B. In addition, the increment of Tₘₐₓ values with the applied voltage was much higher for the composite fiber with higher MWCNT-MHB content. For instance, for the composite fiber containing 30.0 wt % MWCNT-MHB, Tₘₐₓ of ˜68° C. was attained at an applied voltage of 25 V, which was ˜36° C. higher than that of the fiber having 10.0 wt % MWCNT-MHB. On the other hand, it was found that Tₘₐₓ values were quadratically increased with increase in the increment of the applied voltage. These quadratic increments of Tₘₐₓ with the applied voltage are consistent with the changes of electric power with voltages in FIG. 8B, which supports the understanding that the electric power applied to the composite fibers was dominantly dissipated as heat during the electric heating experiments. Therefore, it is suggested that the cellulose/MWCNT-MHB composite fibers could be used for high performance electric heating textiles in a variety of advanced application areas.

### 6. Conclusions

To fabricate environmentally friendly, electrically conductive, and mechanically strong composite fibers, a series of cellulose-based composite fibers reinforced with various MWCNT-MHB contents of 0.5-30.0 wt % were successfully manufactured by a facile wet-spinning method. The SEM images of the cross-sectional and longitudinal views for the composite fibers revealed uniform dispersion of MWCNT-MHB in the cellulose matrix, owing to the hydrogen bonding interaction between chemically-modified functional groups of MWCNT-MHB and hydroxyl groups of the cellulose backbone, which was confirmed by the infrared spectra. As the result, the composite fibers were found to have high mechanical performance of tensile strength of 156-278 MPa, initial modulus of 11.3-13.9 GPa, and failure strain of 3.7-7.0%. The electrical conductivity of the cellulose/MWCNT-MHB composite fibers increased considerably from ˜10⁻⁸ S/cm to ˜10° S/cm with the increment of the MWCNT-MHB content from 0.5 wt % to 30.0 wt %, and the electrical percolation threshold was evaluated to be formed at ˜0.52 wt % MWCNT-MHB. Accordingly, the cellulose composite fiber containing 30.0 wt % MWCNT-MHB, which has high electrical conductivity of 2.7 S/cm and tensile strength of ˜156 MPa, can be applied to electrically conductive wires and electric heating elements in smart textiles.

### 7. Further Examples and Comparative Examples

[1] Except that the multiwall carbon nanotubes (i.e., short MWCNTs (S-MWNT) and long MWNTs (L-MWNT) are subjected to carboxylic acid modification (sample codes: C/S-MWNT-COOH-50 and C/L-MWNT-COOH-50) and then quadruple hydrogen bonding moiety modification (sample codes: C/S-MWNT-QHB-50 and C/L-MWNT-QHB-50), and the amount of the carbon nanotubes are fixed at about 50 wt %, regenerated cellulose/carbon nanotubes composite fibers are prepared in the same manner as set forth above. For the resulting composite fibers, the specific resistivity and the electrical conductivity are measured. The results are summarized in Table 3.

TABLE 3

| | MWNT | Resistivity | Conductivity |
|---|---|---|---|
| Sample code | (product name) | (Ωm) | (S/m) |
| C/S-MWNT-COOH-50 | NC7000 | 1.0 × 10⁻² | 100 |
| C/S-MWNT-QHB-50 | NC7000 | 1.9 × 10⁻³ | 526 |
| C/L-MWNT-COOH-50 | CM250 | 1.8 × 10⁻² | 55.6 |
| C/L-MWNT-QHB-50 | CM250 | 5.0 × 10⁻³ | 200 |

[2] Except that the multiwall carbon nanotubes (i.e., short MWCNTs (S-MWNT) and long MWNTs (L-MWNT) are subjected to carboxylic acid modification (sample codes: C/S-MWNT-COOH-50 and C/L-MWNT-COOH-50) and then quadruple hydrogen bonding moiety modification (sample codes: C/S-MWNT-QHB-50 and C/L-MWNT-QHB-50), and the amount of the carbon nanotubes are fixed at about 60 wt %, regenerated cellulose/carbon nanotubes composite fibers are prepared in the same manner as set forth above. For the resulting composite fibers, the specific resistivity and the electrical conductivity are measured. The results are summarized in Table 4.

TABLE 4

| | MWNT | Resistivity | Conductivity |
|---|---|---|---|
| Sample code | (product name) | (Ωm) | (S/m) |
| C/S-MWNT-COOH-60 | NC7000 | 3.2 × 10⁻³ | 312 |
| C/S-MWNT-QHB-60 | NC7000 | 1.1 × 10⁻³ | 909 |
| C/L-MWNT-COOH-60 | CM250 | 1.9 × 10⁻³ | 526 |
| C/L-MWNT-QHB-60 | CM250 | 1.3 × 10⁻³ | 769 |

From the results of Table 3 and Table 4, it follows that using CNTs modified with a quadruple hydrogen bonding moiety may bring about enhancement of electrical properties of the composite in comparison with the composite including CNTs modified with COOH.

While this disclosure has been described in connection with what is presently considered to be practical exemplary embodiments, it is to be understood that the present disclosure is not limited to these embodiments, but, on the contrary, is intended to cover various modifications and equivalent arrangements included within the spirit and scope of the appended claims.

What is claimed is:

1. An electrically conductive composite comprising:
a polymer matrix comprising a cellulose; and
a plurality of electrically conductive carbon nanoparticles dispersed in the polymer matrix,
wherein the electrically conductive carbon nanoparticles have a multiple hydrogen bonding moiety on a surface thereof.

2. The electrically conductive composite of claim 1, wherein the cellulose comprises a regenerated cellulose.

3. The electrically conductive composite of claim 1, wherein the electrically conductive carbon nanoparticles comprise a carbon nanotube, a graphene nanoparticle, a carbon nanofiber, carbon black, a carbonized nano-cellulose, or a combination thereof.

4. The electrically conductive composite of claim 1, wherein the multiple hydrogen bonding moiety comprises at least two hydrogen-bonding sites.

5. The electrically conductive composite of claim 1, wherein the multiple hydrogen bonding moiety comprises at least two moieties selected from a urea moiety, a pyridine moiety, a pyrimidine moiety, a pyrimidinone moiety, a triazine moiety, a purine moiety, an ether moiety, an amino moiety, an amide moiety, a naphthyridine moiety, and —CF₃.

6. The electrically conductive composite of claim 1, wherein the multiple hydrogen bonding moiety comprises a moiety represented by any one of Chemical Formulae 1 to 4 or a derivative thereof: 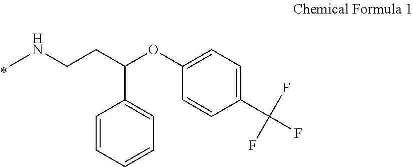 [SMILES: CNCCC(Oc1ccc(C(F)(F)F)cc1)c1ccccc1]
wherein * depicts linking to an adjacent atom; 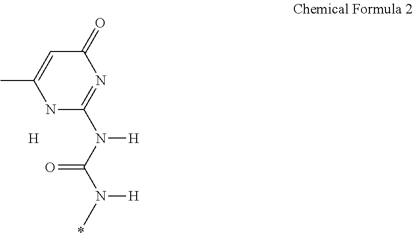
wherein * depicts linking to an adjacent atom; 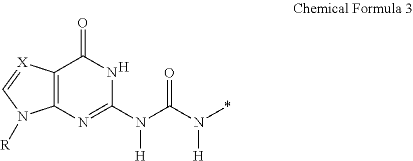
wherein
X is —CH═ or —N═,
R is H or a C1 to C10 alkyl, and
* depicts linking to an adjacent atom; and 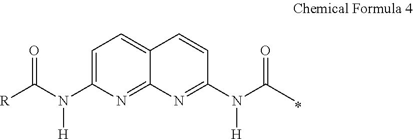
wherein
R is a substituted or unsubstituted C1 to C10 alkyl group or a substituted or unsubstituted C6 to C40 aryl group, and
* depicts linking to an adjacent atom.

7. The electrically conductive composite of claim 1, wherein the multiple hydrogen bonding moiety is bonded to the electrically conductive particles via a linker derived from a diisocyanate group.

8. The electrically conductive composite of claim 1, wherein an amount of the electrically conductive carbon nanoparticles is greater than or equal to about 0.5 percent by weight and less than or equal to about 60 percent by weight, based on the total weight of the electrically conductive composite.

9. The electrically conductive composite of claim 1, wherein the composite is a fiber, a film, a fiber assembly, or a combination thereof.

10. The electrically conductive composite of claim 9, wherein the composite is a composite fiber and the composite fiber has a tensile strength of greater than or equal to about 150 megaPascals and an initial modulus of greater than or equal to about 11 gigaPascals.

11. The electrically conductive composite of claim 1, wherein the composite has electrical conductivity of greater than or equal to about 9×10⁻⁴ Siemens per meter.

12. A composition for preparing an electrically conductive composite, comprising:
a cellulose;
a plurality of electrically conductive carbon nanoparticles having a multiple hydrogen bonding moiety covalently bound to a surface thereof;
dimethyl acetamide; and
lithium chloride,
wherein the cellulose is dispersed in the composition without being precipitated.

13. The composition of claim 12, wherein composition comprises:
about 0.1 percent by weight to about 20 percent by weight of lithium chloride;
about 0.1 percent by weight to about 20 percent by weight of the cellulose;
about 0.01 percent by weight to about 30 percent by weight of the electrically conductive carbon nanoparticle; and
a balance of dimethylacetamide, based on the total weight of the composition.

14. The composition of claim 12, wherein the multiple hydrogen bonding moiety of the electrically conductive carbon nanoparticle comprises at least two moieties selected from a urea moiety, a pyridine moiety, a pyrimidine moiety, a pyrimidinone moiety, a triazine moiety, a purine moiety, an ether moiety, an amino moiety, an amide moiety, a naphthyridine moiety, and —CF₃.

15. The composition of claim 12, wherein the multiple hydrogen bonding moiety comprises a moiety represented by any one of Chemical Formulae 1 to 4 or a derivative thereof: 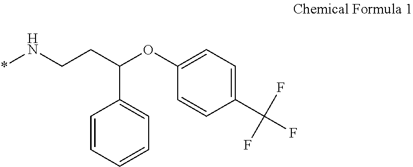 [SMILES: *NCCC(Oc1ccc(C(F)(F)F)cc1)c1ccccc1]
wherein * depicts linking to an adjacent atom; 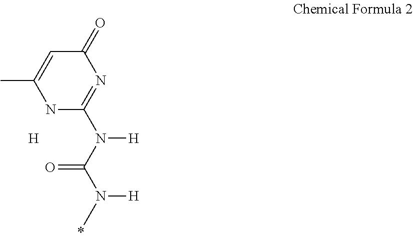
wherein * depicts linking to an adjacent atom; 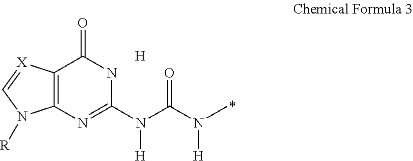
wherein
X is —CH═ or —N═,
R is H or a C1 to C10 alkyl, and
* depicts linking to an adjacent atom; and 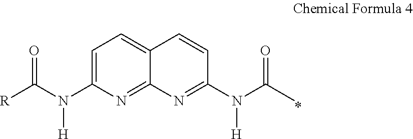
wherein
R is a substituted or unsubstituted C1 to C10 alkyl group or a substituted or unsubstituted C6 to C40 aryl group, and
* depicts linking to an adjacent atom.

16. An electronic device comprising the composite of claim 1.
